(19) United States
(12) Patent Application Publication
(10) Pub. No.: US 2011/0011191 A1
(43) Pub. Date: Jan. 20, 2011

(54) Ball-screw drive with axial bearing

(75) Inventors: Juergen OSTERLAENGER, EMSKIRCHEN (DE); Josef MIKO, EMSKIRCHEN (DE); Stefanie BAERTHLEIN, BAUDENBACH (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/829,639

(22) Filed: Jul. 2, 2010

(30) Foreign Application Priority Data
Jul. 4, 2009 (DE) 10 2009 031 709.0

(51) Int. Cl. F16H 25/20; F16C 33/46

(52) U.S. Cl. 74/89.23; 384/623

(57) ABSTRACT

A ball-screw drive, which has a spindle nut arranged on a threaded spindle and an axial bearing which is arranged so as to act on the threaded spindle and which has a bearing part arranged so as to be rotatable relative to the threaded spindle. The bearing part is arranged so as to be captively retained on the threaded spindle by a captive retention means.

### FIELD OF THE INVENTION

The present invention relates to a ball-screw drive having a spindle nut arranged on a threaded spindle. In ball-screw drives of said type, a relative rotation between the spindle nut and the threaded spindle is converted into an axial relative movement between the threaded spindle and the spindle nut.

### BACKGROUND OF THE INVENTION

DE 40 21 572 A1, for example, discloses a disk brake system of a vehicle in which a brake caliper engages around a brake disk, with it being possible for the brake disk to be clamped between the brake linings by virtue of a brake piston being pressed against one of the brake linings. The brake piston is connected to a spindle nut of a ball-screw drive which is arranged, with the interposition of balls, on a threaded spindle. The threaded spindle can be set in rotation by means of an electric motor, wherein by means of the relative rotation between the threaded spindle and the spindle nut, the brake piston which is connected to the spindle nut can be moved axially relative to the threaded spindle in the direction of the brake linings. The threaded spindle is mounted on a housing of the brake device by means of an axial bearing, such that the axial brake force exerted by the brake piston can be introduced via said axial bearing into the housing. In said design, the axial bearing has a plurality of bearing parts: a rolling body ring which is formed from a multiplicity of rolling bodies arranged distributed over the circumference, if appropriate an axial bearing cage, in the pockets of which the rolling bodies are arranged, and if appropriate axial bearing disks to both sides of the rolling bodies.

During the assembly of ball-screw drives of said type in particular in brake devices of said type, the axial rolling bearing is conventionally placed onto the threaded spindle, and the pre-assembled ball-screw drive is finally inserted into the housing. Axial rolling bearings, for example, are composed of a multiplicity of individual parts, such that a multiplicity of assembly steps is required during the assembly of brake devices of said type.

### OBJECT OF THE INVENTION

It was an object of the present invention to specify a ball-screw drive according to the features of the preamble of claim 1 which is simple to assemble.

### SUMMARY OF THE INVENTION

According to the invention, said object was achieved by means of the ball-screw drive according to claim 1. Since the bearing part which is arranged so as to be rotatable relative to the threaded spindle is arranged by way of a captive retention means on the threaded spindle or on a shaft section fixedly connected to the threaded spindle, it is for example possible for an axial bearing cage which is equipped with rolling bodies to be pre-assembled onto the threaded spindle, such that the ball-screw drive with said pre-assembled bearing part can be installed for example into a housing directly and without further assembly measures. Assembly errors are hereby eliminated.

Whereas an axial bearing cage which is equipped with rolling bodies is provided in one particularly preferred variant according to the invention, it is also possible for an axial bearing disk of an axial rolling bearing to be regarded as a further or alternative bearing part which is arranged so as to be rotatable relative to the threaded spindle, wherein said axial bearing disk may additionally be equipped with the rolling bodies.

It is however also possible to provide an axial plain bearing instead of an axial rolling bearing, such that, in an alternative refinement according to the invention, the bearing part which is arranged so as to be rotatable relative to the threaded spindle is formed by a plain bearing disk which is arranged so as to be captively retained on the threaded spindle by the captive retention means.

As a captive retention means, it is expedient to provide for example resiliently elastically deflectable detents or fingers or other snap-action means which engage into a receptacle provided on the threaded spindle, such that the bearing part is captively retained.

The receptacle which is provided on the threaded spindle may be formed for example by an encircling annular groove or else by an embossing, in which for example by means of a targeted displacement of material of the threaded spindle, an encircling bead can be generated such that the bearing part is held correctly on the threaded spindle in the axial direction by means of the bead.

In one refinement according to the invention, the axial bearing is formed by an axial rolling bearing which has an axial bearing cage with pockets which are arranged distributed over the circumference and which serve to hold rolling bodies, with said axial bearing cage being provided with detents which are formed, for example, by tongues and which engage into a receptacle of the threaded spindle. Said tongues are preferably of resiliently elastic design, such that when the axial bearing cage is pushed onto the threaded spindle, said tongues, as they deflect, engage into said receptacle.

Said detent may be formed as a cage rim arranged on the inner circumference of the axial bearing cage. Said cage rim is then preferably of thin-walled design such that it has resiliently elastic properties in order to deflect radially inward into said receptacle.

The cage rim may be of approximately polygonal design as viewed along the spindle axis and may engage with its elastically expandable polygon sides into the receptacle.

The axial bearing may have a spindle disk which is provided with an axial bearing surface and which is provided with a circumferentially acting stop for the spindle nut. In a ball-screw drive refined in this way, said circumferentially acting stop prevents an undesired tightening of the spindle nut when the latter sets down on the spindle disk; this is because, before the spindle nut can be clamped axially against said spindle disk by means of a screwing movement, the circumferentially acting stop engages and prevents a further relative rotation between the spindle nut and the spindle disk.

In particular when using ball-screw drives according to the invention in brake devices for actuating a brake, it may be expedient for said spindle disk to be arranged on the threaded spindle duly so as to be held in a positively locking fashion in both rotational directions but so as to be capable of performing a tumbling motion. The arrangement which enables a tumbling motion prevents an undesired wedging of individual components, such that correct operation of the ball-screw drive according to the invention can be ensured. When ball-screw drives according to the invention are mounted on brake calipers, the limbs of the brake caliper can be expanded by the axially acting brake force; the angle-adjustable spindle disk adapts to said expansion and ensures correct operation. The arrangement of the spindle disk in a positively locking fashion in the rotational directions is expedient if a stop, which can transmit a torque upon abutment, acts between the spindle disk and the spindle nut.

The spindle disk is preferably axially supported on a thrust bearing. Said thrust bearing may be realized by means of a preferably spherically shaped shoulder formed on the threaded spindle, such that the spindle disk, which is for example provided with a conically shaped bearing surface, is supported on said spherical shoulder so as to be capable of performing a tumbling motion.

### BRIEF DESCRIPTION OF THE DRAWINGS

The invention is explained in more detail below on the basis of two exemplary embodiments which are depicted in a total of ten figures, in which:

FIG. 1 shows a ball-screw drive according to the invention in a perspective illustration;

FIG. 2 shows the ball-screw drive from FIG. 1 with a partial section;

FIG. 3 shows the ball-screw drive according to the invention from FIG. 1 in longitudinal section;

FIGS. 4 and 5 show an individual part of the ball-screw drive according to the invention from FIG. 1;

FIG. 6 shows a further ball-screw drive according to the invention in longitudinal section;

FIGS. 7 and 8 show an individual part of the ball-screw drive according to the invention from FIG. 6; and

FIGS. 9 and 10 show a further individual part of the ball-screw drive according to the invention from FIG. 6.

### DETAILED DESCRIPTION OF THE DRAWINGS

FIG. 1 shows a ball-screw drive according to the invention in a perspective illustration. A spindle nut 1 is rotatably mounted on a threaded spindle 2. The threaded spindle 2 has a narrowed shaft section 3 which is provided with a spindle disk 4 and an axial rolling bearing 5. The drivable threaded spindle 2 can be supported in the axial direction on a housing (not shown here) via the axial rolling bearing 5.

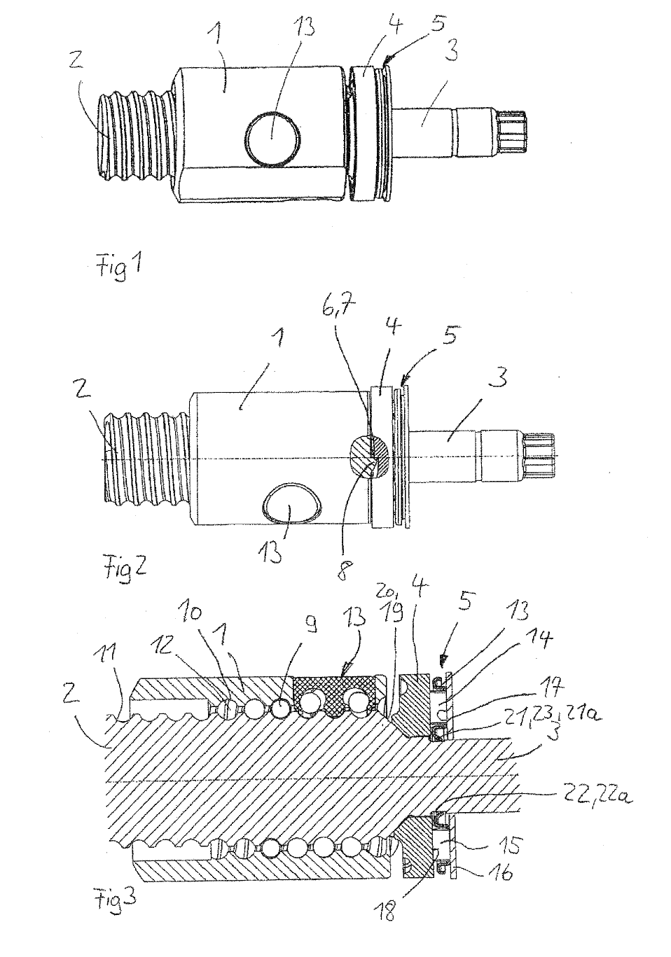

FIG. 2 shows the ball-screw drive according to the invention from FIG. 1, but with a partial section. It can be seen from the figure that the spindle disk 4 has, on its side facing toward the spindle nut 1, a wedge-shaped recess 6 which runs in the circumferential direction and which forms a stop 7 for the spindle nut 1. It can be seen from the figure that the spindle nut 1 is provided, on its end side facing toward the spindle disk 4, with a projection 8 which abuts against the stop 7.

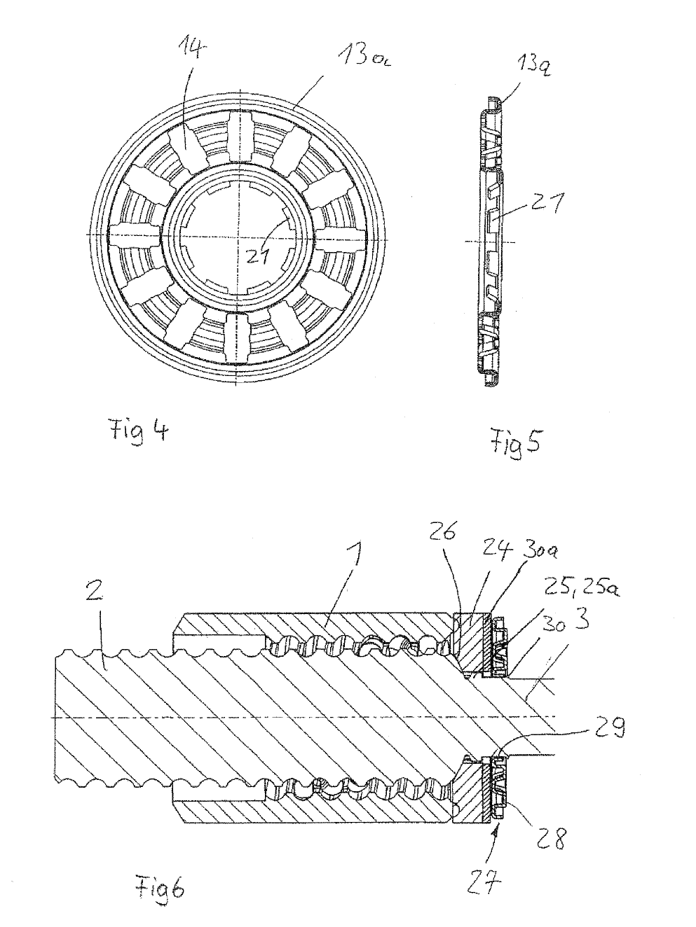

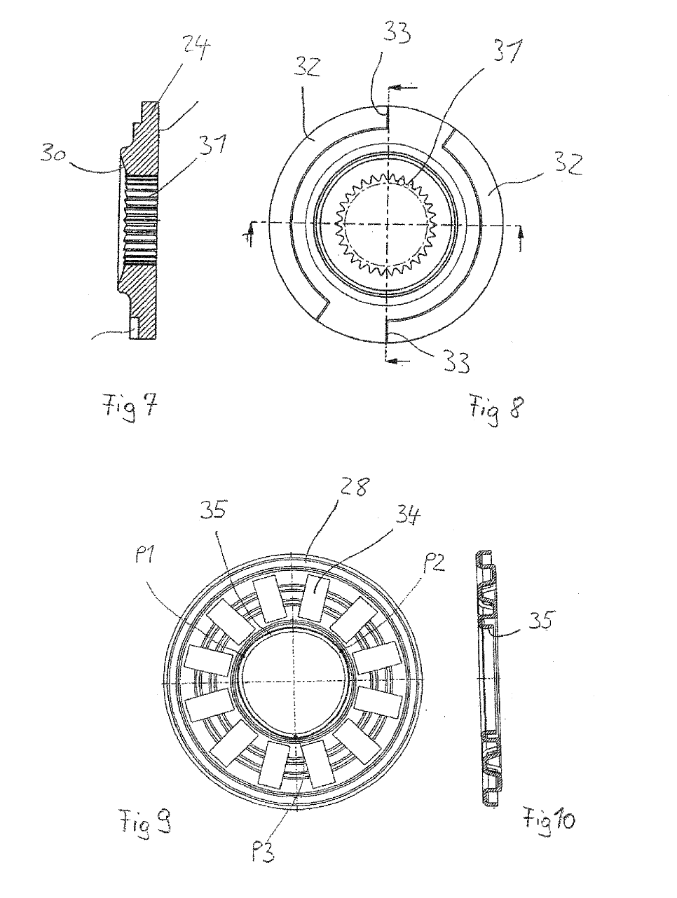

FIG. 3 shows the ball-screw drive according to the invention in longitudinal section. It can be seen from the figure that the spindle nut 1 is mounted on the threaded spindle 2 by means of balls 9. The balls 9 roll on ball grooves 10, 11 which are coiled helically around the spindle axis and which are formed on the ball nut 1 and on the threaded spindle 2. Said ball grooves 10, 11 delimit endless ball channels 12 in which the balls 9 circulate in an endless fashion. Said ball-screw drive is provided with a ball deflection 13 as is known per se, such that the balls 9 are deflected from a start to an end of the endless ball channel 12.

It can also be seen from FIG. 3 that the axial rolling bearing 5 has an axial bearing cage 13a, in the pockets 14 of which rollers 15, which are formed as rolling bodies, are held. Also provided here is an axial bearing disk 16 which is arranged on the narrowed shaft section 3 and which is provided, on its end side facing toward the rollers 15, with a raceway 17 for the rollers 15. Said axial bearing disk 16 is optional and may also be omitted if a corresponding raceway for the rollers 15 is formed on the housing already mentioned above. It can also be seen from the figure that the spindle disk 4 is provided, on its end side facing toward the rollers 15, with a raceway 18 for the rollers 15.

The spindle disk 4 is arranged on the narrowed shaft section 3 of the threaded spindle 2 in a positively locking fashion in both rotational directions by means of a spline toothing, wherein the spindle disk 4 is however arranged on said narrowed shaft section 3 so as to be capable of performing a tumbling motion.

It can also be seen from FIG. 3 that a shoulder 19 which is provided between the threaded spindle 2 and the narrowed shaft section 3, which adjoins said threaded spindle 2 in an integral fashion, is formed as a thrust bearing 20 for the spindle disk 4. The force flow in the axial direction is accordingly conducted from the spindle nut 1 via the balls 9 into the threaded spindle 2, and from there via the shoulder 19 into the spindle disk 4 and the axial rolling bearing 5.

FIGS. 4 and 5 show the axial bearing cage 13a in two views. It can be seen from the two figures that a multiplicity of pockets 14 arranged distributed over the circumference is provided for holding the rollers 15 (not shown here). The axial bearing cage 13a itself is produced from thin sheet metal in a non-cutting forming process. A multiplicity of resilient tongues 21 is formed on the inner circumference of the axial bearing cage 13a. Said resilient tongues 21 latch into an annular groove 22 which is formed on the narrowed shaft section 3 of the ball-screw spindle 2 (FIG. 3). The tongues 21 accordingly form detents 21a and the annular groove 22 forms a receptacle 22a for said detents 21a.

Said axial bearing cage 13a may be pushed onto the narrowed shaft section 3, with the resilient tongues 21 finally snapping into said annular groove 22 with a release of stress. The annular groove 22 forms a receptacle for the tongues 21. The axial bearing cage 13a is therefore captively held on the threaded spindle 2. The rollers 15 conventionally snap into the pockets 14 of the axial bearing cage 13a, such that the axial bearing cage 13a, pre-assembled with the rollers 15, is formed as a structural unit together with the threaded spindle 2 and the spindle nut 1. The resilient tongues 21 together with the annular groove 22 form a captive retention means 23.

FIG. 6 shows a further ball-screw drive according to the invention in longitudinal section. Said ball-screw drive according to the invention differs from the above-described ball-screw drive substantially by modifications to the spindle disk and to the axial rolling bearing, as is explained in more detail below.

Like the spindle disk described above, a spindle disk 24 is arranged on the narrowed shaft section 3 of the threaded spindle 2 in a positively locking fashion in both rotational directions by means of a spline toothing 25. FIG. 6 shows that the threaded spindle 2 is provided, on its narrowed shaft section 3, with teeth 25a which are of axially short construction and which are part of the spline toothing 25. As is the case in the exemplary embodiment described above, said spindle disk 24 is arranged on the shaft section 3 so as to be capable of performing a tumbling motion. The teeth 25a of axially short construction promote the capability of the spindle disk 24 to perform a tumbling motion. The spindle disk 24 is supported on a shoulder 26 which is formed on the threaded spindle 2 at the transition to the stepped shaft section 3.

Furthermore, an axial rolling bearing 27 is captively held on the threaded spindle 2. An axial bearing cage 28 engages with its inner circumference into a receptacle 29 formed on the shaft section 3, which receptacle 29 is delimited in the axial directions at one side by the spindle disk 24 and at the other side by an encircling bead 30 which has been generated by material deformation on the shaft section 3.

It can also be seen from FIG. 6 that an axial bearing disk 30a is arranged between the axial bearing cage 28 and the spindle disk 24. Said axial bearing disk 30a may also be omitted if the spindle disk 24 is already provided with a raceway for the rolling bodies of the axial rolling bearing.

FIGS. 7 and 8 show the spindle disk 24 in longitudinal section and in a view, wherein both figures clearly show an internal toothing 31 as part of the spline toothing 25. At its end side facing toward the shoulder 26, the spindle disk 24 is provided with a conical opening 31 which is adapted to the shoulder 26 of the threaded spindle 2 and enables a tumbling motion of the spindle disk 24.

It can be seen in particular from FIG. 8 that the spindle disk 24 is provided, on its end side facing toward the spindle nut 1, with two recesses 32 which are arranged in the circumferential direction and which run axially in a wedge shape and which end in each case at a stop 33. Projections (not shown in any more detail) on the spindle nut 1 engage into said recesses 32 and abut against said stops 33 before axial clamping between the spindle nut 1 and the axial bearing disk 24 can occur.

FIGS. 9 and 10 show the axial bearing cage 28 in a view and in a sectional illustration. In particular, FIG. 9 shows pockets 34, which are arranged distributed in the circumferential direction, for rollers (not shown here) as rolling bodies. Said axial bearing cage 28 is likewise produced from thin sheet metal in a non-cutting forming process. The inner circumference of the axial bearing cage 28 is formed by an encircling rim 35 which is however not of cylindrical design but rather is of approximately polygonal shape.

In FIG. 9, a total of three points P1, P2 and P3 are marked at which said rim 35 is situated furthest remote from the cage axis. Between said points, the cage rim 35 moves closer to the cage axis, wherein in the present case the section of the cage rim 35 situated centrally between two successive points P1, P2, P3 is situated closest to the cage axis. An imaginary envelope circle enclosed by said cage rim 35 is tangent to the cage rim 35 at said centrally situated sections. The diameter of said imaginary envelope circle is smaller than the outer diameter of the bead 30 which is embossed on the shaft section 3 of the threaded spindle 2.

The axial bearing cage 28 is pushed onto the shaft section 3, with the free end of the cage rim 35 facing away from the bead 30. When the cage rim 35 is pushed over the bead 30 with axial displacement of the axial bearing cage 28, the cage rim 35 deflects radially outwards with its sections situated centrally between the points P1, P2, P3, and said cage rim 35 springs back radially inward with a release of stress when the free end of the cage rim 35 has passed the bead 30. Said central sections accordingly form detents 37 which latch into the receptacle 29. The axial bearing cage 28 can subsequently no longer be pulled axially off the shaft section 3 without special measures. The cage rim 35 together with the bead 30 forms a captive retention means 36 which holds the axial bearing cage 28 captively on the shaft section 3 of the threaded spindle 2.

The exemplary embodiments described here present snap-action connections between the axial bearing cage and the shaft section, which snap-action connections permit easy assembly of the axial bearing cage but simultaneously prevent inadvertent disassembly.

The shaping at the inner circumference of the axial bearing cages according to the invention permits good inner guidance of the cage on the shaft section 3. By means of the invention, not only is the assembly of the ball-screw drives pre-assembled with said axial rolling bearings facilitated, but the cage arranged in captively retained fashion simultaneously captively holds the spindle disk on the threaded spindle 2. Here, the receptacle provided on the shaft section 3 for the axial bearing cage is dimensioned in the axial direction such that the axial bearing cage has sufficient axial play, wherein it is however ensured that the spindle disk cannot slide out of its seat on the shaft section 3.

Whereas the exemplary embodiments described here present axial rolling bearings with an axial bearing cage composed of metal, it is self-evidently also possible to provide plastic cages with captive retention means according to the invention.

Ball-screw drives according to the invention are expediently suitable for use in an electromechanical parking or service brake with integrated brake caliper.

It may also be considered to be a particular advantage of the invention that no additional components are required for providing the captive retention means. In fact, the captive retention means can be provided simply by means of the special shaping of the axial bearing cage in interaction with the special shaping of the shaft section 3. The provision of said captive retention means according to the invention can therefore be realized in a cost-neutral fashion.

### LIST OF REFERENCE SYMBOLS

1 Spindle nut
2 Threaded spindle
3 Shaft section
4 Spindle axis
5 Axial rolling bearing
6 Wedge-shaped recess
7 Stop
8 Projection
9 Ball
10 Ball groove
11 Ball groove
12 Ball channel
13 Ball deflection
13a Axial bearing cage
14 Pocket
15 Roller
16 Axial bearing disk
17 Raceway
18 Raceway
19 Shoulder
20 Thrust bearing
21 Tongue
21a Detent
22 Annular groove
22a Receptacle
23 Captive retention means
24 Spindle disk
25 Spline toothing
25a Tooth
26 Shoulder
27 Axial rolling bearing
28 Axial bearing cage
29 Receptacle
30 Bead
30a Axial bearing disk
31 Internal toothing
32 Recess
33 Stop
34 Pocket
35 Cage rim
36 Captive retention means
37 Detent

1. A ball-screw drive, comprising:
a spindle nut arranged on a threaded spindle; and
an axial bearing which is arranged on the threaded spindle and which has a bearing part arranged so as to be rotatable relative to the threaded spindle,
wherein the bearing part is arranged so as to be captively retained on the threaded spindle by a captive retention means.

2. The ball-screw drive of claim 1, wherein the axial bearing is an axial rolling bearing arranged on the threaded spindle, an axial bearing cage, which forms the bearing part, of which axial rolling bearing is provided with pockets which are distributed over a circumference and in which rolling bodies are arranged, with the axial bearing cage having a detent which engages into a receptacle of the threaded spindle.

3. The ball-screw drive of claim 2, in which wherein the detent is formed on an inner circumference of the axial bearing cage.

4. The ball-screw drive of claim 3, wherein a cage rim, which is formed on the inner circumference, is approximately polygonal as viewed along the spindle axis, and engages with elastically expandable polygon sides into the receptacle.

5. The ball-screw drive of claim 1, wherein the axial bearing has a spindle disk which has an axial hearing surface and a circumferentially acting stop for the spindle nut.

6. The ball-screw drive of claim 5, wherein the spindle disk is arranged on the threaded spindle in a positively locking fashion in both rotational directions on the spindle axis but so as to be capable of performing a tumbling motion.

7. The ball-screw drive of claim 6, wherein the spindle disk is supported axially on a thrust bearing.

8. The hall-screw drive of claim 7, wherein the thrust bearing is formed by a shoulder formed on the threaded spindle.

9. The ball-screw drive of claim 1, wherein the captive retention means has snap-action means which snap into a receptacle of the threaded spindle.
